(19) United States
(12) Patent Application Publication
(10) Pub. No.: US 2021/0259230 A1
(43) Pub. Date: Aug. 26, 2021

(54) ADAPTER FOR AUTOMATION OF DETECTION DEVICES, REMOTE, AUTOMATIC AND UNINTERRUPTED COUNTING OF TARGET PESTS AND LEPIDOPTERAN PERIMETER CONTROLLER

(71) Applicant: Joelcio COSME CARVALHO ERVILHA, Brasília (BR)

(72) Inventor: Joelcio COSME CARVALHO ERVILHA, Brasília (BR)

(21) Appl. No.: 17/314,656

(22) Filed: May 7, 2021

Related U.S. Application Data
(63) Continuation of application No. PCT/BR2019/050478, filed on Nov. 3, 2019.

(30) Foreign Application Priority Data
Nov. 8, 2018 (BR) 10 2018 072956 0

(51) Int. Cl. A01M 1/02; A01M 1/10

(52) U.S. Cl. CPC A01M 1/02; A01M 1/106

(57) ABSTRACT

An adapter is provided that is specially designed for coupling to traps existing in the market, with no need for any change in them, including the dynamics of entry, perforations and physical structure. The adaptation includes automating the detection, continuous remote counting, and perimeter control of lepidopterans. Its application is in the agricultural sector within the most distinct crops and sectors, being the main ones: grain storage and, in agricultural production areas (cotton, soy, corn, beans, coffee, cocoa, orange, sugar cane, African palm, among others).

### CROSS-REFERENCE TO RELATED APPLICATIONS

This application is a continuation of International Patent Application No. PCT/BR2019/050478, filed Nov. 3, 2019, which claims priority from Brazilian Patent Application No. 10 2018 072956 0, filed Nov. 8, 2018, and these applications are incorporated herein by reference for all purposes as if fully set forth herein.

### TECHNICAL FIELD OF THE INVENTION

The present invention comprises an adapter specially designed for coupling to the traps existing in the market, with no need for any changes in the traps, including the entry dynamics, perforations and physical structure. The adaptation comprises automating the detection, continuous remote counting, and perimeter control of lepidopterans. Its application is in the agricultural sector, within the most distinct cultures and sectors, being the main ones: grain storage and, in agricultural production areas (cotton, soy, corn, beans, coffee, cocoa, orange, sugar cane, African palm, among others).

### TECHNIQUE STATUS

The monitoring of agricultural pests is an activity of high operational cost and burdens the producer when developed inadequately, causing losses in production and reducing product quality. The monitoring work basically comprises two principles, the direct visual control in the production, and the monitoring of pest insects by means of traps that attract them.

In direct visual monitoring, the professional analyzes the insect-pest populations directly on the plant. Due to the technical complexity required to monitor, such as the evaluation of the population and the stage of development of the pest, many professionals choose to change activity, resulting in high turnover of these and a difficulty in training such professionals with in-depth knowledge on the subject, increasing the chance of wrong readings and records. This process is costly (training, labor costs, among others) and prone to errors, due to the lack of specialization of many technicians who perform it. To reduce this problem, much has been developed with software and applications that are installed in smartphones and/or tablets, so that the professionals who perform the monitoring read and record the insect-pests, and this information is then sent to a central system that gathers and processes the data, to facilitate decision making. However, this process is still subject to human error and also does not have the possibility to perform the reading in real time, since it develops with the need for manpower in the field.

Another monitoring group is the use of traps, which are structures designed to attract and prevent the exit of pest insects. The traps are installed in agricultural areas and rely on the use of decoys (pheromone, lighting, among others), which attract the pest insects, which when captured are recorded by professionals when they make the on-site inspection, usually at weekly intervals. This process is the most widespread worldwide, because it facilitates the monitoring work, even though it has limitations such as the need for skilled labor for reading, recording and interpretation. These traps are called conventional traps.

The monitoring process, in traps, depends on the use of insecticides or a container for storing the captured or dead insects in order to perform the count. However, some crops of great commercial importance, such as cotton, have restrictions on the use of insecticides, thus being a great technical challenge to ensure the actual count.

Currently, new traps are being developed, with different designs, materials and formats than the conventional ones, for the installation of sensors, cameras, or other devices that allow the automatic reading of the populations of pest insects to be monitored. However, these traps still have low acceptance of use, when compared to conventional traps, because their new designs have not been fully tested and the vast expertise that already exists in the use of conventional traps has not been fully defined, making them susceptible to sampling errors, generating distrust by the end user.

The adapter proposed here has the ability to be installed in conventional traps, and for its set of sensors to take readings automatically. The fact that it has more than one sensor allows it to count the insects, according to the order of the interrupted signals, allowing the algorithm to segregate in counts of incoming and outgoing insects. The counting in both directions is a great differential proposed, since it doesn't require the use of insecticides, for the killing and counting of insects, nor large deposits for storing insects. The adaptor will facilitate the mechanism of counting these insects, facilitating the intervention strategies and reducing, considerably, the impact of the use of chemical inputs during the production period.

Currently, there is no solution that has the proposal of this application, in any of the economic sectors that have the monitoring of pests as a focus, mainly because it makes a fine adjustment to something already widely recognized, used and adopted, which are the conventional monitoring traps. The adaptor proposes the improvement of already widely used traps, facilitating the reading, counting and sending of information, automatically, according to the captures made in the conventional trap.

The proposed technology brings to conventional traps the possibility of, from its installation, to perform an automatic, remote and real-time count of the captured insects. To this end, the adapter respects the design of the original trap, especially in the internal capture chamber, and also respects the inclination and the perforations that may already exist in the device for its correct installation.

The adapter is small and light enough not to change in any way the way conventional traps are used, being able to be used in the most different contexts, such as agricultural fields under the same climatic conditions as the trap.

### BRIEF DESCRIPTION OF THE DRAWINGS

FIG. 1. Complete view of a model of adapter (A) and its support (B) for installing the sensors. The support (B) has a conical shape, with the same angle as the cone of the conventional trap, and with perforations (P) to allow the passage of light and exhale the pheromone from the trap, as happens in the conventional trap. The adapter (A) also has a cubic shape with a platform (F) where the sets of sensors are installed, the item responsible for the automation of the reading process of the insect at the time of its passage, either entering or leaving the counting chamber, via interruption of the signals.

FIG. 2. Front view, to visualize the entrance section (R) of the sensor set. In the support (B) perforations (P) were made for the passage of light and to exhale the pheromone, as with the conventional trap.

FIG. 3: Top view, to visualize the insect passage channel (C). The dimensions of the channel are identical to the dimensions of conventional traps, not generating interference for the movement of insects to the counting chamber of conventional traps, varying the dimension between 5 mm and 30 cm in length.

FIG. 4. side view, to view the section (R) where the sensor assemblies will be.

FIG. 5: Vertical Front Cut of the adapter (A) and support (B), respecting the angulation of the conventional trap and with the perforations that allow the passage of light and exhalation of the pheromone by the trap. The support (B) with the appropriate perforations (P) and the insect passage channel (C), and the Section (R) for installation of the set of sensors.

FIG. 6. Horizontal cut with top view of the adapter (A), for viewing the platform (F), the insect passage channel (C), respecting the dimension of the conventional trap system. B—support; P—perforations.

FIG. 7. Adapter (A) with Vertical Cut and Lateral View, for viewing the insect passage channel (C), which maintains the passage dynamics, existing at the exit of the conventional trap. B—support; P—perforations.

FIG. 8. Actual view of the assembly of the conventional trap and adapter (A) with the system of 2 sets of sensors (S) connected for insect counting.

FIG. 9. Real view of the conventional trap with the proposed adapter (A), in working condition, and highlighting the passage of the wires that will be connected to the sensors for its correct operation. In the example, the adapter (A) was fixed with plastic glue, but the same can be done with wire, metallic wire, or clips, to connect the perforations of the support (B) (conical part) with the perforations of the conventional trap (conical part).

FIG. 10. Actual view of conventional trap with adapter (A) installed, and with closure performed and ready for field operation.

FIG. 11. Base box (D) for installing the electrical and electronic components that will be connected to the adapter with sensors.

FIG. 12. Complete trap/adapter system operating in the field, with a spring box connected to all electrical and electronic components and to the adapter with its respective sensors duly installed.

FIG. 13. Adapter model (A), with support (B), perforations (P), sensors (S) installed near the insect passage channel (C), and protective cover (T).

FIG. 14. Adapter model (A), with trap (0), sensors (S) connected, insect passage channel (C), support (B), and simulation of the signals (V) from the sensors, where counting will occur by interrupting them.

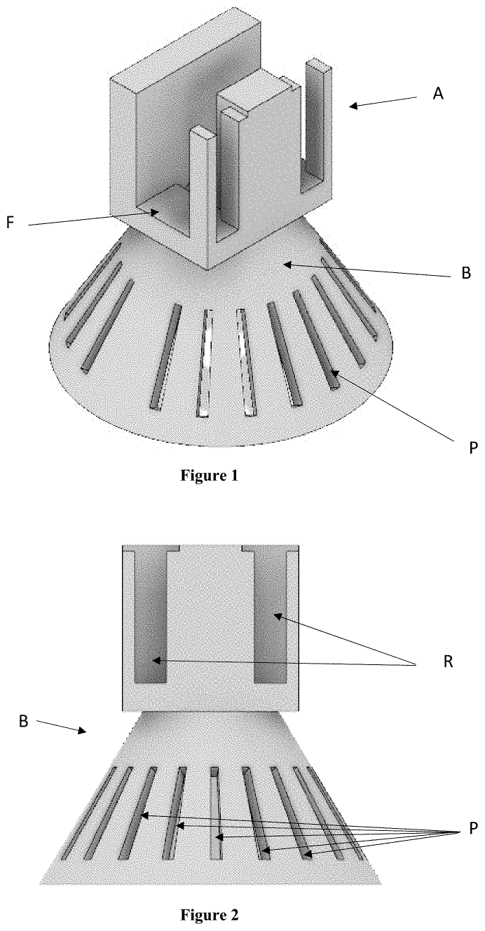

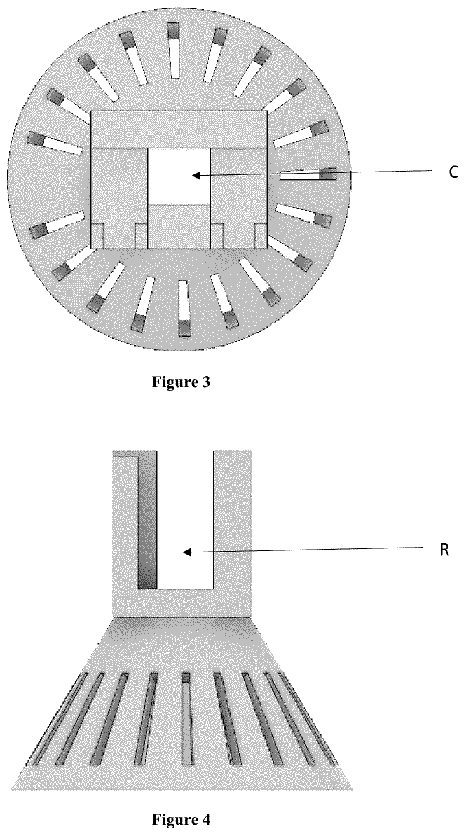

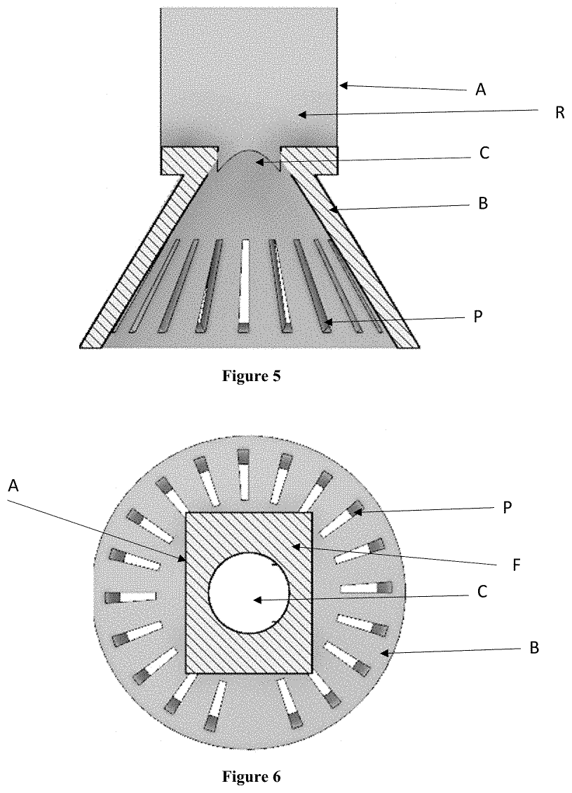

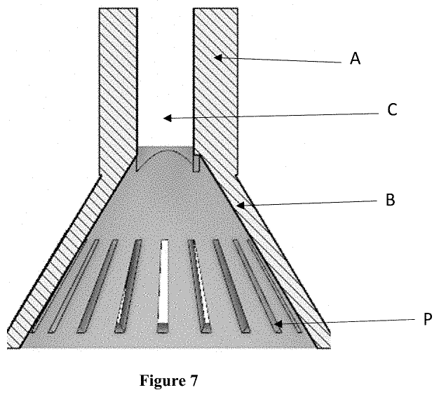

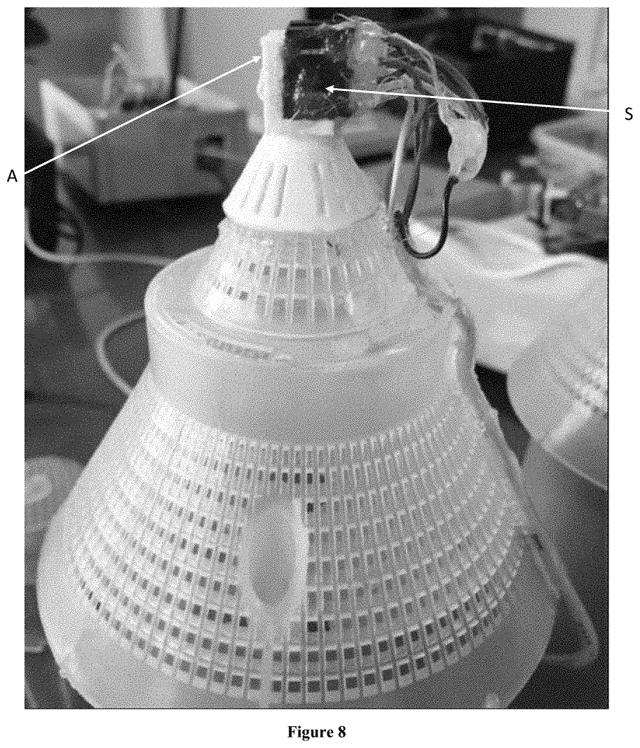

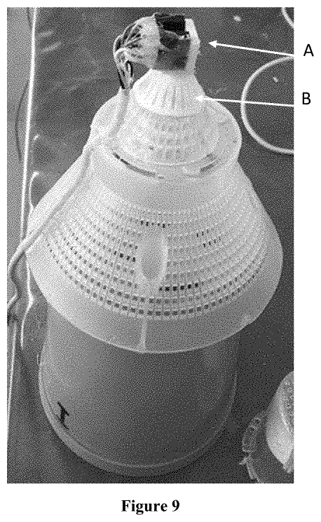

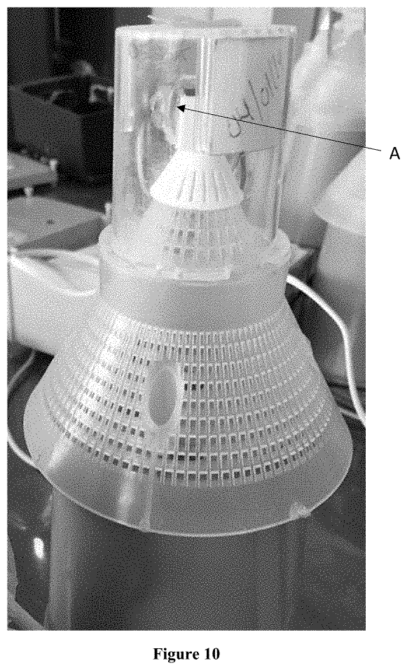

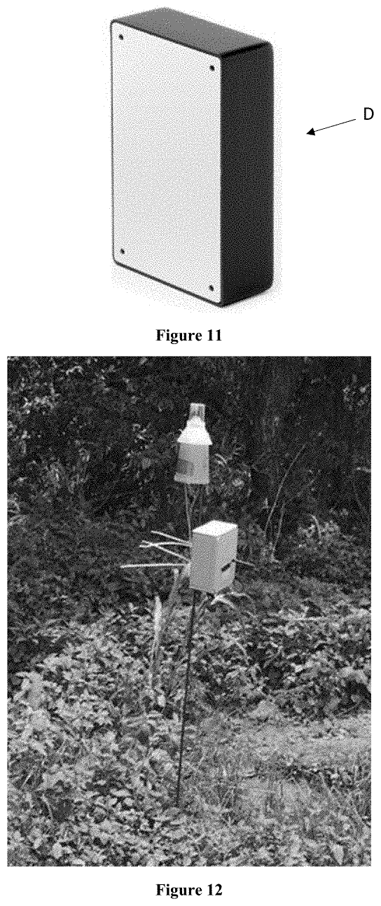

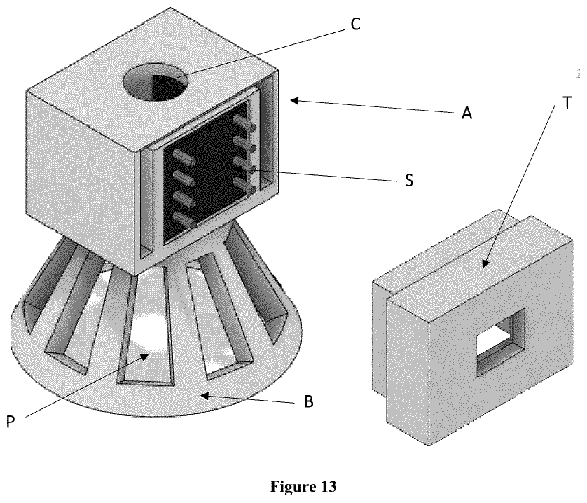

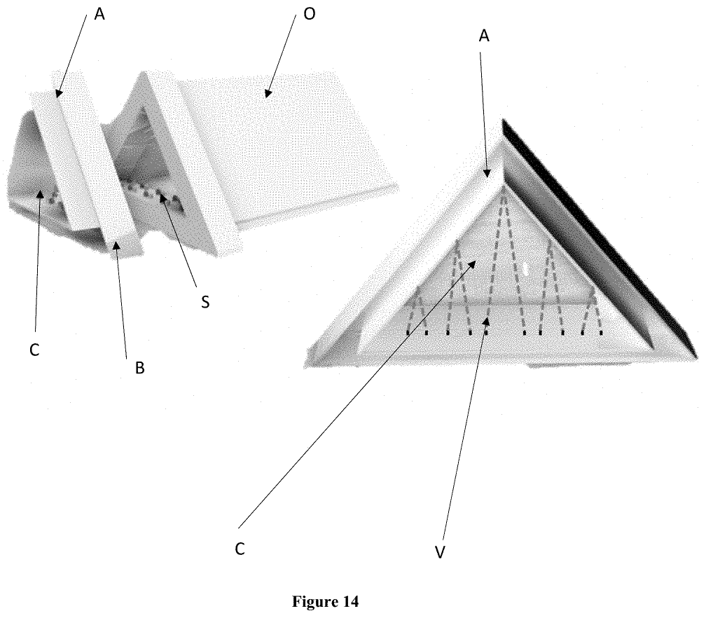

### BRIEF DESCRIPTION OF THE INVENTION

The technology proposed here comprises an adapter, specially designed for coupling to conventional traps, with no need for any changes to the traps, including pest entry dynamics, perforations, and physical structure.

This adapter comprises a plastic structure adaptable to each conventional trap format, being a device adapted to the dimensions of the conventional traps for counting pest insects, in which it is attached to the trap through its base. The insect then passes through the trap and is conducted directly into the channel of the device, where sensors are positioned, emitting constant signals that, when interrupted by the passage of the insect, carry out an automatic and remote count of the insects. The insects are stored in the counting chamber, in the same way as the system without the adapter. Additionally, the adapter has a slot for the installation of an ultrasonic sensor, which performs the perimeter control of lepidopterans, by mimicking their natural predator (bats).

The proposed adapter is therefore a dongle that allows the conventional trap counting system to be improved, via the use of sensors.

### DETAILED DESCRIPTION OF THE PREFERRED EMBODIMENTS

The adapter (A) is a rigid plastic modular structure made of ABS type material or similar, of adjustable format to the trap, with an insect passage channel (C), varying in color according to the pest insect and trap that it acts on, supported by a base called support (B), with perforations (P) in the vertical direction throughout its structure, allowing the passage of light, and exhalation of the pheromone/flame and the possibility of its attachment to the structure of the conventional trap, respecting the same angle, between 0° and 90°, of the conventional trap. The opening for the insect-pest passage of the adapter (A) is identical to that of the conventional trap, varying between 5 mm and 30 cm. Along the insect passage channel (C) an extension is projected, where the set of sensors (S) is installed. This extension can be from 0.5 cm to 30 cm. The support (B) of the adapter (A) has the same shape as the conventional trap, with a diameter of 2.5 cm and height of 2 cm.

The adapter (A) is attached to the conventional trap, through which the insect will move until it exits the conventional trap's capture chamber, since its interest lies in the pheromone inside the chamber.

The insect when moving through the passage channel (C), interrupts the signal from the set of sensors (S), positioned in a section (R) perpendicular to this passage. The sensors (S), located on a platform (F), used in the adapter (A) can be electrical, optical, mechanical and/or magnetic, such as infrared, piezoelectric, bioimpedance, temperature, humidity, key switch, ultrasonic, among others, depending on the insect-pest to be monitored. These are powered by 3.3V and 5V batteries, with load capacity of 2,000 mAh to 100,000 mAh, and connected by metal wires to the microcontroller, which is inside a plastic cabinet (D) for storing the electric and electronic components. The plastic cabinet (D) is made of rigid plastic material, of ABS-type material or similar, waterproof and UV-resistant, and installed just below the conventional trap, separately.

The microcontroller installed can be of the Arduino or ESP type, or similar to these, consisting of a processor core, memory, and support that receives the programmable sensors, processes the information received, and sends it to the communication module, which transmits the information through the data network. The insect entering the trap and passing through the first sensor interrupts the signal, and then passing through the second sensor, also interrupting the signal, causes the algorithm to recognize 1 count entering the capture camera. The reverse path, passing through the second sensor, interrupting the signal, and then the first sensor, interrupting the signal, causes the algorithm to recognize 1 output count.

The algorithm is also designed so that at certain times of the day, the counts performed and stored in the microcontroller's electronic memory, are sent via low-power wide-area network (LPWAN) signals, such as Sigfox or LoRa or similar, to a central web platform (website), which receives the data and sends them to a data management software that will store and process the count information for each installed trap.

The management software for the captured data accounts for all the information received and projects the results on heat maps, tables, and reports, so that the user can know, in real time, the number of insects that entered and left each geographically identified trap that has the adapter installed, helping in the decision making process.

### Demonstration Experiments

The proposed adapter has its prototype already developed and tested at the laboratory level, for the cotton bollworm insect pest (Anthonomus grandis).

The laboratory test consisted of:
1 working trap with the adapter installed.
Release 1 insect, cotton bollworm, and observe its entry into the chamber,
Remove the adapter and repeat the insect entry test
Observation and notes.

In the laboratory experiment, two traps were set, one conventional and one with the adapter installed, and these traps were placed in an open environment, inside transparent plastic boxes, with 30 insects in each box. At the end of each day the captured insects were removed and counted in the counting chamber of the traps, and then the traps were exchanged from one box to another. The experiment was conducted for 6 days. According to the data in Table 1, the adapter did not represent obstacles to the insects' passage into the counting chamber, showing itself to be an inert element to the operation of the conventional trap, with the advantage of increasing the counting efficiency, automating the process, its final objective.

TABLE 1
Insect Counts in a Comparative Test of
Conventional and Adapter Traps.

| Trap | Day 1 | Day 2 | Day 3 | Day 4 | Day 5 | Day 6 |
|---|---|---|---|---|---|---|
| Conventional | 20 | 13 | 23 | 26 | 25 | 12 |
| Conventional + | 18 | 16 | 21 | 22 | 28 | 14 |
| Adapter | | | | | | |

Additionally, as it does not alter the operation of a conventional trap, used worldwide, it creates the possibility of using this adapter to automate the process of identification and counting of the insect immediately after its installation.

### CONCLUSION

The adapter complements the monitoring of pest insects through traps, which are widely used worldwide. The traps already in use generate a base of information and confidence in the development of productive activities, but at the same time, they suffer from logistical and human limitations, due to various impediments to monitoring in large areas and making decision-making difficult.

Conventional traps, with analogical responses and dependent on manual monitoring, are now automatically converted into automatic tools, with instantaneous responses and maintaining all the same dynamics and performance of operation.

1. An adapter characterized by comprising a rigid plastic modular structure, of adjustable shape to the insect monitoring trap; with a passage channel (C) of the insect similar to the trap that is installed; supported by a support (B), with perforations (P); powered by rechargeable batteries; connected by metallic wires to the microcontroller, and stored in a plastic cabinet for electronic equipment (D).

2. The adapter of claim 1, characterized by the modular rigid plastic structure being made of ABS-type material or similar, having a variant coloring according to the insect-pest, and having an opening at its base ranging from 5 mm to 30 cm.

3. The adapter of claim 1, wherein the insect passage channel (C) has a sensor array and length between 0.5 cm and 30 cm.

4. The adapter of claim 1, characterized by the support (B) having condition for correct coupling to the conventional trap, respecting dimensions (diameter of 2.5 cm and height of 2 cm) and angulation (between 0° and 90°), not generating any physical change in it.

5. The adapter of claim 1, characterized in that the rechargeable batteries are 3.3V to 5V, with a charge capacity of 2,000 mAh to 100,000 mAh.

6. The adapter of claim 1, characterized in that the microcontroller is of Arduino or ESP type, or the like; comprising a processor core, memory, and supporting a set of programmable sensors (S), which may be of electrical, optical, mechanical, and/or magnetic type, such as infrared, piezoelectric, bioimpedance, temperature, humidity, key switch, ultrasonic among others; processing the received data; and sending it to the remote communication module via low-power wide-area network (LPWAN), such as Sigfox or LoRa, or similar.

7. The adapter of claim 1, characterized in that the plastic cabinet (D) is made of rigid, waterproof, UV-resistant plastic material, and installed adjacent to the conventional trap separately.
